(19) United States
(12) Patent Application Publication
(10) Pub. No.: US 2010/0161615 A1
(43) Pub. Date: Jun. 24, 2010

(54) INDEX ANAYSIS APPARATUS AND METHOD AND INDEX SEARCH APPARATUS AND METHOD

(75) Inventors: Joo-young LEE, Daejeon-si (KR); Do-won HONG, Daejeon-si (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon-si (KR)

(21) Appl. No.: 12/580,714

(22) Filed: Oct. 16, 2009

(30) Foreign Application Priority Data
Dec. 19, 2008 (KR) 10-2008-0130678

(51) Int. Cl. G06F 17/30; G06F 12/00

(52) U.S. Cl. 707/741; 707/E17.014

(57) ABSTRACT

Provided are an index analysis apparatus and method, and an index search apparatus and method. The index analysis apparatus extracts indexes from digital data, which is included in a disk image of a virtual drive, by using pattern matching, and the index search apparatus receives the extracted indexes and searches the digital data, which includes the received indexes, using a keyword keyed in by a user. Accordingly, the accuracy of digital forensic analysis can be increased, and digital forensic search can be sped up.

### CROSS-REFERENCE TO RELATED APPLICATION

This application claims the benefit under 35 U.S.C. §119(a) of Korean Patent Application No. 10-2008-0130678, filed on Dec. 19, 2008, the disclosure of which is incorporated by reference in its entirety for all purposes.

### BACKGROUND

1. Field

The following description relates to information search technology, and more particularly, to digital forensic search technology.

2. Description of the Related Art

Digital forensics is, from a procedural perspective, a scientific and logical technique involving collecting, keeping, analyzing, and reporting data. In terms of purpose, digital forensics is a technique of examining and proving the facts regarding an action, which occurred using a computer, based on digital data stored in the computer.

For digital forensics, original digital data must be obtained intact as evidence, and the existence of the computer evidence at a specified time must be proved. After the evidence is analyzed, it must be documented for presentation in a court of law. Digital evidence search technology is a core digital forensic technology and is essentially used by an investigator to find conclusive or relevant information related to a crime in large storage medium within a limited period of time.

### SUMMARY

The following description relates to an index analysis apparatus and method and an index search apparatus and method which can increase accuracy of digital forensic analysis and speed up digital forensic search.

According to an exemplary aspect, there is provided an index analysis apparatus including: a virtual drive generation unit generating a virtual drive for digital data collected as evidence; an index analysis unit extracting indexes from the digital data, which is included in a disk image of the generated virtual drive, by using pattern matching; and a database storing the digital data having the extracted indexes, wherein in the pattern matching, the digital data is compared with a preset pattern, and parts, which match the preset pattern, are searched for in the digital data.

According to another exemplary aspect, there is provided an index search apparatus including an index search unit receiving indexes, which are extracted using pattern matching from digital data included in a disk image of a virtual drive, and searching the digital data, which includes the received indexes, using a keyword keyed in by a user.

According to another exemplary aspect, there is provided an index analysis method including: generating a virtual drive for digital data collected as evidence; extracting indexes from the digital data, which is included in a disk image of the generated virtual drive, by using pattern matching; and storing the digital data having the extracted indexes, wherein in the pattern matching, the digital data is compared with a preset pattern, and parts, which match the preset pattern, are searched for in the digital data.

According to another exemplary aspect, there is provided an index search method including receiving indexes, which are extracted using pattern matching from digital data included in a disk image of a virtual drive, and searching the digital data, which includes the received indexes, using a keyword keyed in by a user.

Other objects, features and advantages will be apparent from the following description, the drawings, and the claims.

### BRIEF DESCRIPTION OF THE DRAWINGS

FIG. 1 is a block diagram of an index analysis apparatus according to an exemplary embodiment;

FIG. 2 is a block diagram of an index analysis unit included in the index analysis apparatus of FIG. 1;

FIG. 3 is a block diagram of an index search apparatus according to an exemplary embodiment;

FIG. 4 is a block diagram of an index search apparatus according to another exemplary embodiment;

FIG. 5 is a flowchart illustrating an index analysis method according to an exemplary embodiment; and

FIG. 6 is a flowchart illustrating an index search method according to an exemplary embodiment.

Other features will become apparent to those skilled in the art from the following detailed description, which, taken in conjunction with the attached drawings, discloses exemplary embodiments of the invention.

### DETAILED DESCRIPTION

The invention is described more fully hereinafter with reference to the accompanying drawings, in which exemplary embodiments of the invention are shown. Descriptions of well-known functions and constructions are omitted to increase clarity and conciseness. Also, the terms used in the following description are terms defined taking into consideration the functions obtained in accordance with the present invention, and may be changed in accordance with the option of a user or operator or a usual practice. Therefore, the definitions of these terms should be determined based on the entire content of this is specification.

An index analysis apparatus and an index search apparatus according to an exemplary embodiment are used for digital forensics. Digital forensics is the process of collecting, analyzing, and searching data to produce electronic evidence that is to be presented to judicial authorities. Digital forensics makes it possible to obtain evidence and clues that were not previously obtainable.

An index analysis apparatus and an index search apparatus according to an exemplary embodiment analyze and search data using an indexing method. In the indexing method, an index is generated for data that is to be analyzed, so that the data can be quickly retrieved using the generated index. When the indexing method is used, desired data can be obtained within seconds.

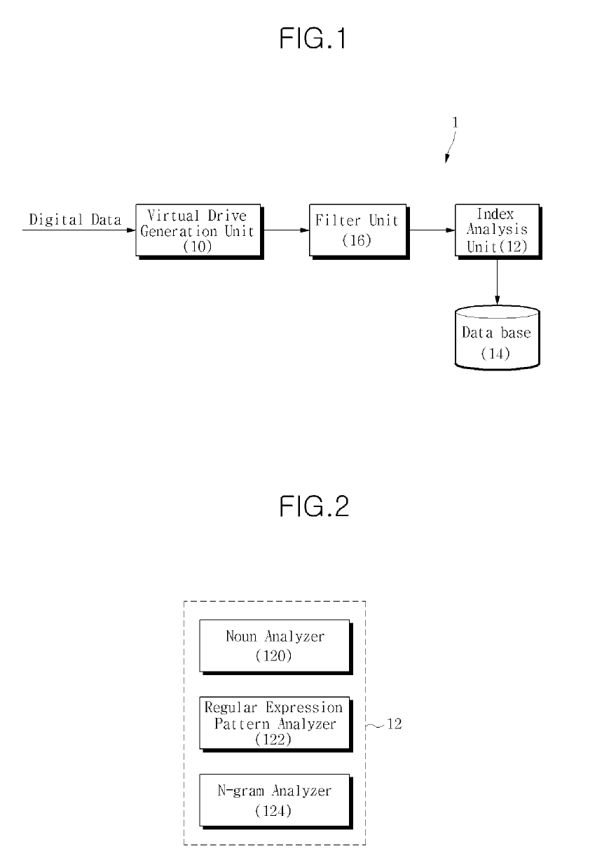

FIG. 1 is a block diagram of an index analysis apparatus 1 according to an exemplary embodiment. Referring to FIG. 1, the index analysis apparatus 1 according to the current exemplary embodiment includes a virtual drive generation unit 10, an index analysis unit 12, a database 14, and a filter unit 16.

The virtual drive generation unit 10 generates a virtual drive for digital data collected as evidence. That is, the virtual drive generation unit 10 generates a virtual drive for a forensic image collected as evidence and provides a user with a structure of directories and files included in a disk image. Then, the user may select a directory and a file, which are to be indexed, from the directories and the files. A virtual drive is generated to prevent damage to digital data (i.e., evidence data), and a disk image is an exact copy of original digital data collected.

When the user selects the directory and the file that are to be indexed, the virtual drive generation unit 10 may store the selected directory and file in a storage device (such as a hard drive, a memory, or the like). In addition, the virtual drive generation unit 10 may recover a deleted or lost file. Here, the contents of the deleted or lost file recovered by the virtual drive generation unit 10 are also indexed. Thus, search efficiency in a digital forensic investigation can be increased.

The index analysis unit 12 extracts indexes from digital data, which is included in a disk image of a virtual drive generated by the virtual drive generation unit 10, by using pattern matching. Pattern matching involves comparing digital data with a preset pattern and finding parts in the data, which match the preset pattern. For example, a noun in a noun is dictionary may be compared with digital data, and indexes corresponding to parts, which match the noun, may be extracted from the digital data. In another example, a regular expression, which is a pattern of characters represented by a set of character strings, may be compared with digital data, and indexes corresponding to parts, which match the regular expression, may be extracted from the digital data. The index analysis unit 12, which generates indexes using pattern matching, will be described in more detail later with reference to FIG. 2.

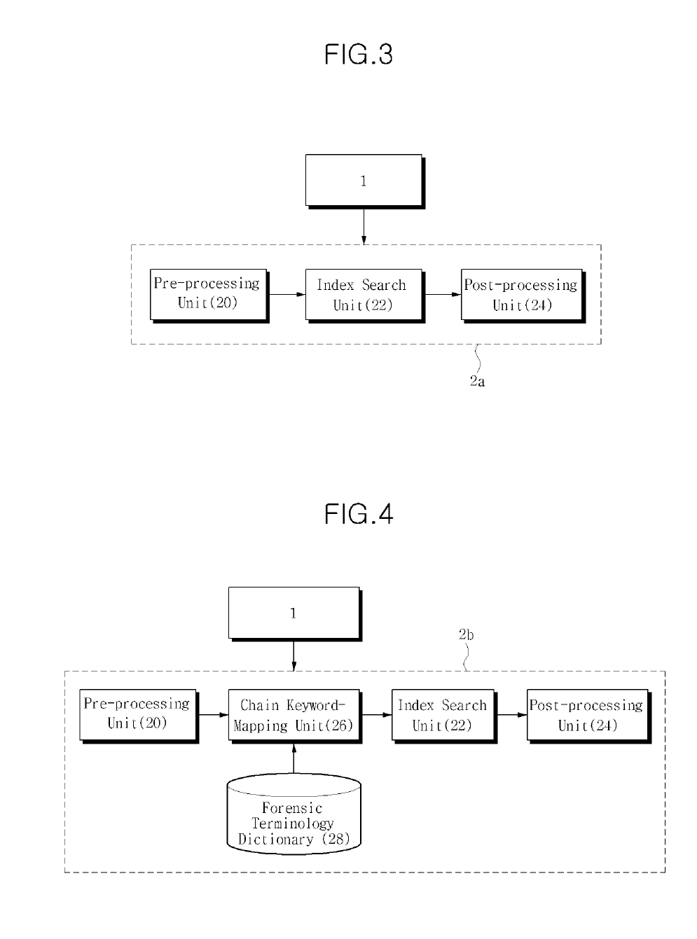

The database 14 stores digital data including extracted indexes. The stored digital data is searched by index search apparatuses 2a and 2b of FIGS. 3 and 4 using keywords. For higher search speed, the database 14 may not use a database management system (DBMS). Instead, the database 14 may be configured in the form of a structured file.

For example, algorithms including, but limited to, a B-tree, a B+-tree, and a TRIE may be used. The B tree is a multi-directional search tree and a tree data structure that allows large files to be efficiently searched and updated. The B+-tree is a tree data structure that represents sorted data in a way that allows for efficient insertion, retrieval and removal of records, each of which is identified by a key. The TRIE is a tree structure composed of nodes that include individual characters of a word. The term “TRIE” comes from “reTRIEval.”

To create the database 14 faster and reduce the size of the database 14, the database 14 may store the name of a document, which contains each index, and a hit rate of each index but may not store location information of each index in a corresponding document. When location information of an index in a document is needed, a user may input a re-search request. Accordingly, the location of the index in the document may be identified. As a result, efficiency of the index search apparatuses 2a and 2b can be increased.

When a user selects data, which is to be indexed, from digital data included in a disk image of a virtual drive generated by the virtual drive generation unit 10, the filter unit 16 extracts text from the selected data and converts the extracted text into unformatted plain text. That is, the filter unit 16 extracts text from files, which have various formats according to application software, and converts the extracted text into plain text. This function makes it possible to index meta information included not only in general documents but also in compressed files, image files, moving-image files, music files, and the like.

Furthermore, when data, which is to be indexed, is encrypted using an encryption algorithm, the filter unit 16 may crack the encrypted data. With increased awareness of security, users often encrypt important documents by using an encryption algorithm provided by an application program. Since encrypted documents are highly likely to contain information that is significant and meaningful to a forensic investigation, the cracking function may be added to the filter 16 when necessary.

FIG. 2 is a block diagram of the index analysis unit 12 included in the index analysis apparatus 1 of FIG. 1. Referring to FIG. 2, the index analysis unit 12 includes a noun analyzer 120, a regular expression pattern analyzer 122, and an N-gram analyzer 124.

The noun analyzer 120 compares digital data with a noun in a pre-stored noun dictionary and extracts indexes corresponding to parts, which match the noun, from the digital data. In digital forensics, unlike in natural language processing search technologies, it is often meaningless to analyze verbs, adverbs, adjectives, and the like. In addition, most keyword queries are in noun form. Accordingly, the noun analyzer 120 according to the current exemplary embodiment does not analyze the entire morpheme. Instead, the noun analyzer 120 analyzes only nouns, thereby extracting indexes more quickly.

Morpheme analysis is a type of conventional analysis methods. In morpheme analysis, rules for interpreting a morpheme are complicated, and the results of interpreting the morpheme are ambiguous. In addition, it is difficult to process unregistered words, and inaccurate indexes can be extracted from an ungrammatical clause. Morpheme analysis also requires a lot of time since each morpheme is parsed and analyzed for its syntax. In word-based analysis which is another analysis method, it is difficult to present accurate results for a keyword query. For example, “morpheme” and “morphemes” are recognized as different words and indexed differently. Thus, when a user enters a keyword “morpheme,” not all of the above two words can be found and presented as search.

On the other hand, the noun analyzer 120 according to the current exemplary embodiment uses a pattern matching-based analysis method. To this end, the noun analyzer 120 uses a noun dictionary from among dictionaries used in conventional morpheme analysis. The noun analyzer 120 compares and analyzes a word, which is registered with the noun dictionary, and text, which is contained in digital data (i.e., a file to be indexed), by using pattern matching. In so doing, the noun analyzer 120 may extract indexes and a hit rate of each of the indexes. This analysis method increases speed of analysis while maintaining accuracy of analysis which is an advantage of morpheme analysis. Accordingly, the noun is analyzer 120 exhibits superior performance when analyzing large forensic data.

The regular expression pattern analyzer 122 compares digital data with a regular expression, which is a pattern of characters represented by a set of character strings, and extracts indexes corresponding to parts, which match the regular expression, from the digital data. A regular expression is a character pattern that is represented by a set of character strings. Data including, but not limited to, e-mails, telephone numbers, and resident registration numbers may be expressed in regular expressions.

According to an embodiment, when a pattern is a resident registration number, the regular expression pattern analyzer 122 may produce a regular expression of [0-9][0-9][0-1][0-9][0-3][0-9]*-*[1-4][0-9][0-9][0-9][0-9][0-9][0-9]. In a pattern board used for pattern matching, data that matches the above regular expression may be indexed, and location information of each index in digital data may be stored. The above patterns (e.g., e-mails, telephone numbers, and resident registration numbers) are highly significant information for a forensic investigation. Nonetheless, a conventional index search apparatus does not support the function of indexing these patterns. On the other hand, the regular expression pattern analyzer 122 according to the current exemplary embodiment can index various patterns, such as e-mails, resident registration numbers and telephone numbers, and extract the location and hit rate of each of the indexes (i.e., patterns).

The N-gram analyzer 124 divides text of digital data into N syllables and extracts indexes corresponding to the N syllables. In the case of a bigram which is a type of N-gram, text is divided into two syllables, and indexes corresponding to the two syllables are generated. For example, from a sentence “a noun is analyzed,” indexes “no”, “ou”, “un”, (“is”), “an”, “na”, “al”, “ly”, “yz”, “ze” and “ed” may be generated. This method may increase a recall ratio. The recall ratio is a ratio of information retrieved under a specified retrieval condition to all information that needs to be retrieved. The recall ratio is one of measures for evaluating performance of an information search system.

FIG. 3 is a block diagram of the index search apparatus 2a according to an exemplary embodiment. Referring to FIG. 3, the index search apparatus 2a according to the current exemplary embodiment includes an index search unit 22, a pre-processing unit 20, and a post-processing unit 24.

Using a keyword keyed in by a user, the index search apparatus 2a according to the current exemplary embodiment searches digital data, which includes indexes, stored in the index analysis apparatus 1. In detail, the index search unit 22 receives indexes, which are extracted using pattern matching from digital data included in a disk image of a virtual drive, from the index analysis apparatus 1 and searches the digital data, which includes the received indexes, using a keyword keyed in by a user.

The pre-processing unit 20 removes stop words, which are meaningless in a search, from a keyword keyed in by a user and changes encoding. Stop words are words that are meaningless and are not used in a search, such as articles, prepositions, auxiliary words, and conjunctions.

The post-processing unit 24 filters search results found by searching digital data, which includes indexes extracted using bigrams, to remove erroneous results and outputs the filtered search results. The output search results may include the name of each document that contains a keyword and a hit rate of the keyword in each document. In addition, the post-processing unit 24 may identify locations of a keyword within each document by searching character strings of each document, add a recognizable effect to the keyword, for example, highlight the keyword, and output the search results accordingly.

When a user makes a search request for a regular expression pattern such as “resident registration number,” the post-processing unit 24 may provide the user with all indexes, which match the regular expression pattern in each document, and locations of the indexes in each document by using analysis results (i.e. the indexes) output from the regular expression pattern analyzer 122 illustrated in FIG. 2. The post-processing unit 24 may add a recognizable effect to the locations of the indexes, for example, highlight the locations, and provide search results accordingly to the user.

FIG. 4 is a block diagram of the index search apparatus 2b according to another exemplary embodiment. Referring to FIG. 4, the index search apparatus 2b according to the current exemplary embodiment includes a pre-processing unit 20, an index search unit 22, a post-processing unit 24, a chain keyword-mapping unit 26, and a forensic terminology dictionary 28.

The pre-processing unit 20 removes stop words, which are meaningless in a search, from a keyword keyed in by a user and performs encoding. The index search unit 22 receives indexes, which are extracted using pattern matching from digital data included in a disk mage of a virtual drive, from the index analysis apparatus 1 and searches the digital data, which includes the received indexes, using a keyword keyed in by a user. The post-processing unit 24 filters search results found by searching digital data, which includes indexes extracted using bigrams, to remove garbage and outputs the filtered search results.

The chain keyword-mapping unit 26 searches the pre-stored forensic terminology dictionary 28 for words associated with a keyword keyed in by a user and transmits an expanded keyword, which is a combination of the found words and the keyword keyed in by the user, to the index search unit 22. Here, the post-processing unit 24 may prioritize search results according to a hit rate of each of the search results and whether each of the search results contains chain keywords in addition to a keyword keyed in by a user and provides the user with the search results in order of priority.

The forensic terminology dictionary 28 is a dictionary that defines forensic terminology used in digital forensics. For example, the forensic terminology dictionary 28 may include terms obtained from a survey of digital forensic experts, terms keyed in by users who conduct digital forensic investigations, and terms obtained through Web searching. Specifically, the forensic terminology dictionary 28 may include terms obtained from a survey of investigators (such as police officers and prosecutors) who have experience in digital forensic investigations and may be edited by forensic investigators. In addition, jargon frequently used on the Web, abbreviated words, and words associated with specified keywords may be periodically collected using an editing medium, which includes a Web agent, and may be automatically updated.

The performing of a search process using an expanded keyword generated by the chain keyword-mapping unit 26 will now be described as an embodiment. When a user keys in a keyword, the chain keyword-mapping unit 26 searches the forensic terminology dictionary 28 for words associated with the keyword and generates an expanded keyword by combining the found words and the keyword keyed in by the user. Then, a search is performed using the expanded keyword. For example, when a user enters a keyword “bribery,” words associated with the keyword, such as “account number” and “bank,” may also be used to perform a search, and search results for these words may be presented to a user. The search results may also be post-processed so that a document in which a specified chain keyword appears most frequently can be presented at the top of a search result page.

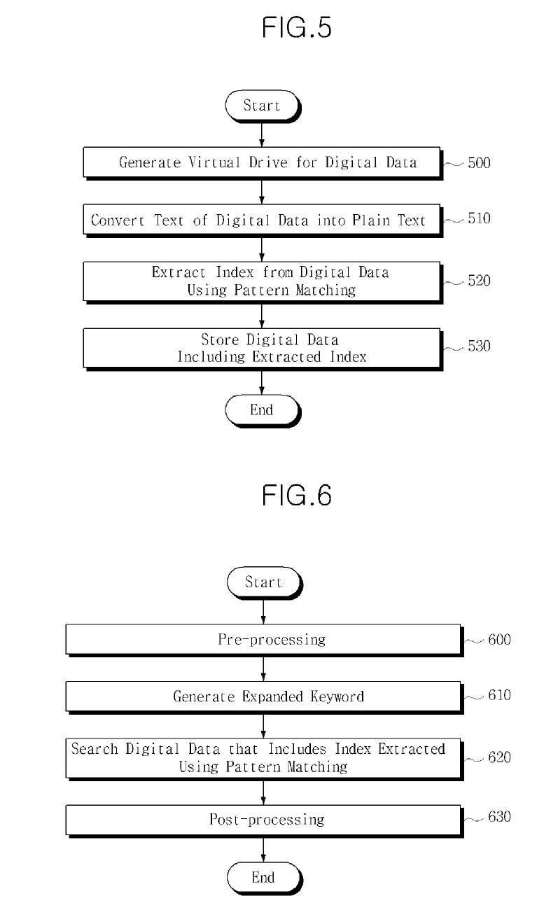

FIG. 5 is a flowchart illustrating an index analysis method according to an exemplary embodiment.

Referring to FIG. 5, the index analysis apparatus 1 of FIG. 1 generates a virtual drive for digital data collected as evidence (operation 500). Then, the index analysis apparatus 1 extracts indexes from the digital data, which is included in a disk image of the generated virtual drive, by using pattern matching (operation 520). Here, the digital data may be compared with a noun in a pre-stored noun dictionary, and indexes corresponding to parts, which match the noun, may be extracted from the digital data. Next, the digital data including the extracted indexes is stored (operation 530).

The index analysis method may further include extracting text from data, which is selected by a user and is to be indexed, and converting the extracted text into unformatted plain text (operation 510) between the generating of the virtual drive (operation 500) and the extracting of the indexes (operation 520).

FIG. 6 is a flowchart illustrating an index search method according to an exemplary embodiment.

Referring to FIG. 6, the index search apparatus 2a or 2b of FIG. 3 or 4 receives indexes, which are extracted using pattern matching from digital data included in a disk image of a virtual drive, and searches the digital data, which includes the received indexes, using a keyword keyed in by a user (operation 620).

The index search method may further include removing stop words, which are meaningless in a search, from the keyword keyed in by the user and performing encoding (operation 600) before operation 620 and may further include filtering search results found by searching digital data, which includes indexes extracted using bigrams, and outputting the filtered search results (operation 630) after operation 620.

The index search method may further include searching a pre-stored forensic terminology dictionary for words associated with the keyword keyed in by the user and generating an expanded keyword by combining the found words and the keyword keyed in by the user (operation 610).

In summary, an index analysis apparatus and an index search apparatus according to an exemplary embodiment can increase accuracy of digital forensic analysis and speed up digital forensic search. That is, since a pattern matching-based indexing method is used, digital data can be analyzed and searched quickly, and a recall ratio can be increased. In addition, accuracy of search can be increased using chain search.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An index analysis apparatus comprising:
a virtual drive generation unit generating a virtual drive for digital data collected as evidence;
an index analysis unit extracting indexes from the digital data, which is included in a disk image of the generated virtual drive, by using pattern matching; and
a database storing the digital data having the extracted indexes.

2. The apparatus of claim 1, wherein the index analysis unit comprises:
a noun analyzer comparing the digital data with a noun in a pre-stored noun dictionary and extracting indexes corresponding to parts, which match the noun, from the digital data; and
a regular expression pattern analyzer comparing the digital data with a regular expression, which is a pattern of characters represented by a set of character strings, and extracting indexes corresponding to parts, which match the regular expression, from the digital data.

3. The apparatus of claim 2, wherein the index analysis unit further comprises an N-gram analyzer dividing text of the digital data into N syllables and extracting indexes corresponding to the N syllables.

4. The apparatus of claim 2, wherein the regular expression that the regular expression pattern analyzer compares with the digital data is a pattern of characters of data from an e-mail, a telephone number, or a resident registration number.

5. The apparatus of claim 1, wherein the index analysis unit analyzes files, which include the indexes extracted from the digital data, a hit rate of each of the extracted indexes in a corresponding one of the files, and a location of each of the extracted indexes in the corresponding one of the files.

6. The apparatus of claim 1, wherein the virtual drive generation unit recovers files deleted or lost from the disk image of the generated virtual drive.

7. The apparatus of claim 1, further comprising a filter unit extracting text from data, which is selected by a user from the digital data included in the disk image of the generated virtual drive and which is to be indexed, and converting the extracted text into unformatted plain text.

8. The apparatus of claim 7, wherein if the selected data, which is to be indexed, has been encrypted using an encryption algorithm, the filter unit decrypts the encrypted data.

9. An index search apparatus comprising an index search unit receiving indexes, which are extracted using pattern matching from digital data included in a disk image of a virtual drive, and searching the digital data, which comprises the received indexes, using a is keyword keyed in by a user.

10. The apparatus of claim 9, further comprising:
a pre-processing unit removing stop words, which are meaningless in a search, from the keyword keyed in by the user and performing encoding; and
a post-processing unit filtering search results found by searching digital data, which includes indexes extracted using bigrams, from among the digital data searched by the index search unit and outputting the filtered search results.

11. The apparatus of claim 9, further comprising a chain keyword-mapping unit searching a pre-stored forensic terminology dictionary for words associated with the keyword keyed in by the user, generating an expanded keyword by combining the found words and the keyword, and transmitting the expanded keyword to the index search unit.

12. The apparatus of claim 11, wherein the forensic terminology dictionary comprises at least one of terms obtained from a survey of digital forensic experts, terms keyed in by users who conduct digital forensic investigations and terms obtained through Web searching.

13. An index analysis method comprising:
generating a virtual drive for digital data collected as evidence;
extracting indexes from the digital data, which is included in a disk image of the generated virtual drive, by using pattern matching; and
storing the digital data having the extracted indexes,
wherein in the pattern matching, the digital data is compared with a preset pattern, and parts, which match the preset pattern, are searched for in the digital data.

14. The method of claim 13, wherein the extracting of the indexes comprises:
comparing the digital data with a noun in a pre-stored noun dictionary and extracting indexes corresponding to parts, which match the noun, from the digital data; and
comparing the digital data with a regular expression, which is a pattern of characters represented by a set of character strings, and extracting indexes corresponding to parts, which is match the regular expression, from the digital data.

15. An index search method comprising receiving indexes, which are extracted using pattern matching from digital data included in a disk image of a virtual drive, and searching the digital data, which comprises the received indexes, using a keyword keyed in by a user.

16. The method of claim 15, further comprising searching a pre-stored forensic terminology dictionary for words associated with the keyword keyed in by the user and generating an expanded keyword by combining the found words and the keyword.
